(19) United States
(12) Patent Application Publication
(10) Pub. No.: US 2021/0240205 A1
(43) Pub. Date: Aug. 5, 2021

(54) MEASURING METHOD USING UNMANNED AERIAL ROBOT AND DEVICE FOR SUPPORTING SAME IN UNMANNED AERIAL SYSTEM

(71) Applicant: LG ELECTRONICS INC., Seoul (KR)

(72) Inventors: Pilwon KWAK, Seoul (KR); Jeongkyo SEO, Seoul (KR); Hyunjai SHIM, Seoul (KR)

(73) Assignee: LG Electronics Inc.

(21) Appl. No.: 16/931,894

(22) Filed: Jul. 17, 2020

(30) Foreign Application Priority Data
Jan. 31, 2020 (KR) 10-2020-0011907

(51) Int. Cl. G05D 1/06; G05D 1/00; G05D 1/08; G01C 5/00; B64C 39/02

(52) U.S. Cl. CPC G05D 1/0607; G05D 1/0094; G05D 1/0816; B64C 2201/162; B64C 39/024; B64C 2201/127; G01C 5/00

(57) ABSTRACT

An altitude measuring method of an unmanned aerial robot is provided. The robot adjusts a level of the unmanned aerial robot so that the robot is at a horizontal state with respect the ground to measure the altitude. The robot generates a plurality of laser beams to the ground, and photographs the ground through the camera. The robot calculates a vertical distance from the ground to the robot based on the photographed image of the ground and the plurality of laser beams.

### CROSS-REFERENCE TO RELATED APPLICATION

This application claims the benefit of Korean Patent Application No. 10-2020-0011907 filed in Korea on Jan. 31, 2020, the entire disclosure of which is hereby incorporated by reference.

### BACKGROUND

### 1. Field

The present disclosure relates to an unmanned aerial system, and more particularly, to an advanced measuring and control method using an unmanned aerial robot and a device supporting the same.

### 2. Background

An unmanned air vehicle is a generic term for an airplane capable of flying and manipulating by induction of radio waves without a pilot, and a helicopter-shaped unmanned aerial vehicle/uninhabited aerial vehicle (UAV). The unmanned aerial vehicles have been increasingly used in various private and commercial fields such as video shooting, unmanned delivery service, and disaster monitoring in addition to military uses such as reconnaissance and attack. For example, a height of a building, a specific indoor structure, etc., which are difficult for people to measure directly, may be easily measured when using an unmanned aerial robot. In the present disclosure, a user can directly or indirectly control the unmanned aerial robot in a safe area to measure the height of the building, the specific indoor structure, etc., which are difficult for user to measure directly.

### BRIEF DESCRIPTION OF THE DRAWINGS

Arrangements and embodiments may be described in detail with reference to the following drawings in which like reference numerals refer to like elements and wherein:

FIG. 1 shows a perspective view of an unmanned aerial robot to which a method in this disclosure may be applied;

FIG. 2 is a block diagram showing a control relation between major elements of the unmanned aerial vehicle of FIG. 1;

FIG. 3 is a block diagram showing a control relation between major elements of an aerial control system according to an embodiment of the present disclosure;

FIG. 4 illustrates a block diagram of a wireless communication system to which methods proposed in this disclosure may be applied;

FIG. 5 is a diagram showing an example of a signal transmission/reception method in a wireless communication system;

FIG. 6 shows an example of a basic operation of the robot and a 5G network in a 5G communication system;

FIG. 7 illustrates an example of a basic operation between robots using 5G communication;

FIG. 8 is a diagram showing an example of the concept diagram of a 3GPP system including a UAS;

FIG. 9 shows examples of a C2 communication model for a UAV;

FIG. 10 is a flowchart showing an example of a measurement execution method to which the present disclosure may be applied;

FIG. 11 briefly shows an example of an altitude measuring method using a drone;

FIG. 12 shows a specific structure of a drone for measuring an altitude according to an embodiment of the present disclosure;

FIG. 13 shows an example of a method for measuring an altitude of a drone according to an embodiment of the present disclosure;

FIG. 14 shows an example of a reference drawing for measuring an altitude of a drone according to an embodiment of the present disclosure;

FIG. 15 shows a specific example of a method for measuring an altitude of a drone according to an embodiment of the present disclosure;

FIG. 16 is a flowchart illustrating a specific example of a method for measuring an altitude of a drone according to an embodiment of the present disclosure;

FIG. 17 is a flowchart illustrating an example of a method for controlling an altitude of a drone according to an embodiment of the present disclosure;

FIG. 18 shows an example of an error that may occur according to a reference drawing according to an embodiment of the present disclosure;

FIG. 19 shows another example of a method for measuring an altitude of a drone according to an embodiment of the present disclosure;

FIG. 20 shows another specific example of a method for measuring an altitude of a drone according to an embodiment of the present disclosure;

FIG. 21 is a flowchart illustrating another specific example of a method for measuring an altitude of a drone according to an embodiment of the present disclosure;

FIG. 22 shows an example of a method for measuring an altitude of a drone indoors according to an embodiment of the present disclosure;

FIG. 23 is a flowchart illustrating an example of an altitude measuring method performed in a drone according to an embodiment of the present disclosure;

FIG. 24 illustrates a block diagram of a wireless communication device according to an embodiment of the present disclosure; and

FIG. 25 illustrates a block diagram of a communication device according to an embodiment of the present disclosure.

### DETAILED DESCRIPTION

Preferred embodiments according to the present disclosure are described in detail with reference to the accompanying drawings. The same reference numerals are assigned to the same or similar elements regardless of their reference numerals, and redundant descriptions thereof are omitted.

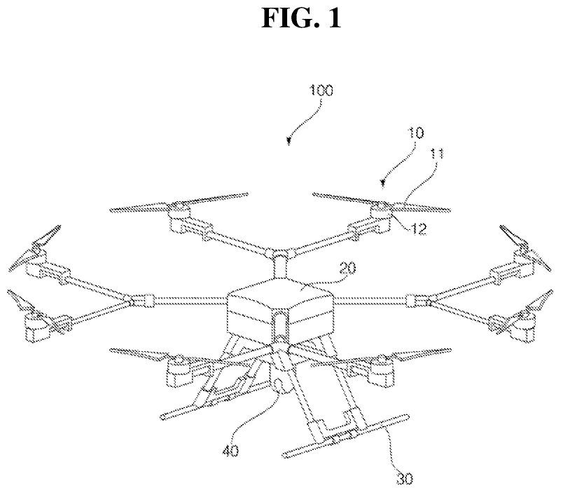

FIG. 1 shows a perspective view of an unmanned aerial robot according to an embodiment of the present disclosure. The unmanned aerial vehicle (or an unmanned aerial robot) 100 is manually manipulated by an administrator on the ground, or it flies in an unmanned manner while it is automatically piloted by a configured flight program. The unmanned aerial vehicle 100, as in FIG. 1, is configured with a main body 20, the horizontal and vertical movement propulsion device 10, and landing legs 30. The main body 20 is a body portion on which a module, such as a task unit 40, is mounted.

The horizontal and vertical movement propulsion device 10 is configured with one or more propellers 11 positioned vertically to the main body 20. The horizontal and vertical movement propulsion device 10 according to an embodiment of the present disclosure includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed by being spaced apart at the bottom of the main body 20. Furthermore, a buffering support member for minimizing an impact attributable to a collision with the ground when the unmanned aerial vehicle 100 makes a landing may be mounted on the bottom of the landing leg 30. The unmanned aerial vehicle 100 may have various aerial vehicle structures different from that described above.

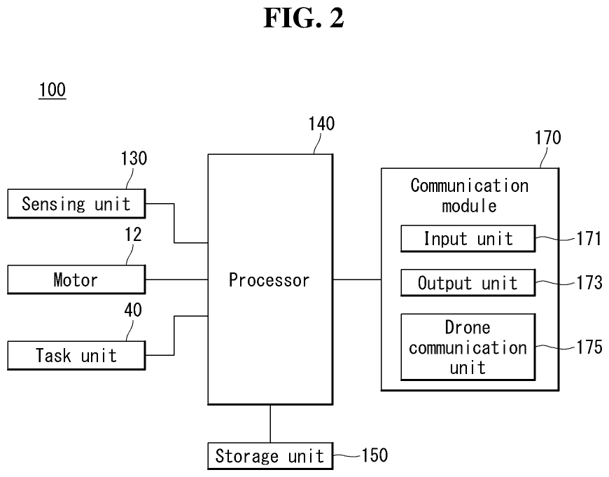

FIG. 2 is a block diagram showing a control relation between major elements of the unmanned aerial vehicle of FIG. 1. The unmanned aerial vehicle 100 measures its own flight state using a variety of types of sensors in order to fly stably. The unmanned aerial vehicle 100 may include a sensing unit 130 including at least one sensor.

The flight state of the unmanned aerial vehicle 100 is defined as rotational states and translational states. The rotational states mean “yaw”, “pitch”, and “roll.” The translational states mean longitude, latitude, altitude, and velocity.

In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (ϕ).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing unit 130 of the present disclosure includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement unit (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (ϕgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (ϕacc)” and “pitch (θacc).” The values are used to remove a bias error included in “roll (ϕgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 (or communication device) for inputting or receiving information or outputting or transmitting information. The communication module 170 may include a drone communication unit 175 for transmitting/receiving information to/from a different external device. The communication module 170 may include an input unit 171 for inputting information. The communication module 170 may include an output unit 173 for outputting information.

The output unit 173 may be omitted from the unmanned aerial vehicle 100, and may be formed in a terminal 300. For example, the unmanned aerial vehicle 100 may directly receive information from the input unit 171. For another example, the unmanned aerial vehicle 100 may receive information, input to a separate terminal 300 or server 200, through the drone communication unit 175.

For example, the unmanned aerial vehicle 100 may directly output information to the output unit 173. For another example, the unmanned aerial vehicle 100 may transmit information to a separate terminal 300 through the drone communication unit 175 so that the terminal 300 outputs the information.

The drone communication unit 175 may be provided to communicate with an external server 200, an external terminal 300, etc. The drone communication unit 175 may receive information input from the terminal 300, such as a smartphone or a computer. The drone communication unit 175 may transmit information to be transmitted to the terminal 300. The terminal 300 may output information received from the drone communication unit 175.

The drone communication unit 175 may receive various command signals from the terminal 300 or/and the server 200. The drone communication unit 175 may receive area information for driving, a driving route, or a driving command from the terminal 300 or/and the server 200. In this case, the area information may include flight restriction area (A) information and approach restriction distance information.

The input unit 171 may receive On/Off or various commands. The input unit 171 may receive area information. The input unit 171 may receive object information. The input unit 171 may include various buttons or a touch pad or a microphone.

The output unit 173 (or output device) may notify a user of various pieces of information. The output unit 173 may include a speaker and/or a display. The output unit 173 may output information on a discovery detected while driving. The output unit 173 may output identification information of a discovery. The output unit 173 may output location information of a discovery.

The unmanned aerial vehicle 100 includes a processor 140 for processing and determining various pieces of information, such as mapping and/or a current location. The processor 140 may control an overall operation of the unmanned aerial vehicle 100 through control of various elements that configure the unmanned aerial vehicle 100.

The processor 140 may receive information from the communication module 170 and process the information. The processor 140 may receive information from the input unit 171, and may process the information. The processor 140 may receive information from the drone communication unit 175, and may process the information.

The processor 140 may receive sensing information from the sensing unit 130, and may process the sensing information. The processor 140 may control the driving of the motor 12. The processor 140 may control the operation of the task unit 40.

The unmanned aerial vehicle 100 includes a storage unit 150 (or storage) for storing various data. The storage unit 150 records various pieces of information necessary for control of the unmanned aerial vehicle 100, and may include a volatile or non-volatile recording medium.

A map for a driving area may be stored in the storage unit 150. The map may have been input by the external terminal 300 capable of exchanging information with the unmanned aerial vehicle 100 through the drone communication unit 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

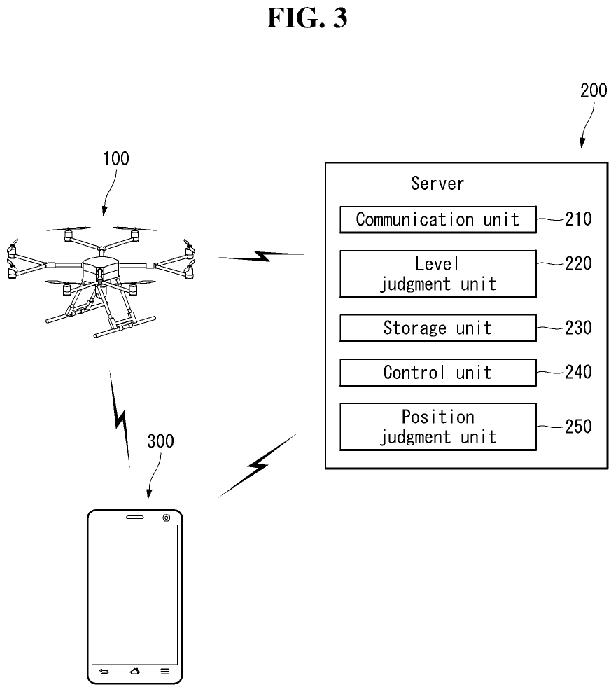

FIG. 3 is a block diagram showing a control relation between major elements of an aerial control system according to an embodiment of the present disclosure. The aerial control system may include the unmanned aerial vehicle 100 and the server 200, or may include the unmanned aerial vehicle 100, the terminal 300, and the server 200. The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

In this disclosure, a base station has a meaning as a terminal node of a network that directly performs communication with a terminal. In this specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station.

Specific terms used in the following description have been provided to help understanding of the present disclosure. The use of such a specific term may be changed into another form without departing from the technical spirit of the present disclosure.

Embodiments of the present disclosure may be supported by standard documents disclosed in at least one of IEEE 802, 3GPP and 3GPP2, that is, radio access systems. That is, steps or portions not described in order not to clearly disclose the technical spirit of the present disclosure in the embodiments of the present disclosure may be supported by the documents. Furthermore, all terms disclosed in this document may be described by the standard documents.

In order to clarify the description, 3GPP 5G is chiefly described, but the technical characteristic of the present disclosure is not limited thereto.

### UE and 5G Network Block Diagram Example

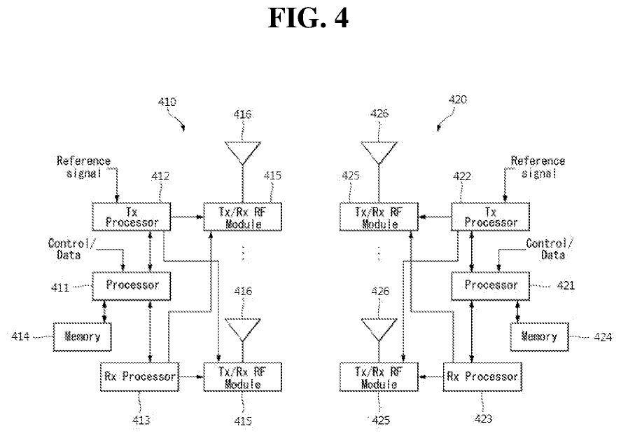

FIG. 4 illustrates a block diagram of a wireless communication system to which methods proposed in this specification may be applied. A drone is defined as a first communication device (410 of FIG. 4). A processor 411 may perform a detailed operation of the drone. The drone may be represented as an unmanned aerial vehicle or an unmanned aerial robot.

A 5G network communicating with a drone may be defined as a second communication device (420 of FIG. 4). A processor 421 may perform a detailed operation of the drone. In this case, the 5G network may include another drone communicating with the drone.

A 5G network maybe represented as a first communication device, and a drone may be represented as a second communication device.

For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 410, the second communication device 420 includes a processor 411, 421, a memory 414, 424, one or more Tx/Rx radio frequency (RF) modules 415, 425, a Tx processor 412, 422, an Rx processor 413, 423, and an antenna 416, 426. The Tx/Rx module is also called a transceiver. Each Tx/Rx module 415 transmits a signal via each antenna 426. The processor implements the above-described function, process and/or method. The processor 421 may be related to the memory 424 for storing a program code and data. The memory may be referred to as a computer-readable recording medium. More specifically, in the DL (communication from the first communication device to the second communication device), the transmission (TX) processor 412 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 410 using a method similar to that described in relation to a receiver function in the second communication device 420. Each Tx/Rx module 425 receives a signal through each antenna 426. Each Tx/Rx module provides an RF carrier and information to the RX processor 423. The processor 421 may be related to the memory 424 for storing a program code and data. The memory may be referred to as a computer-readable recording medium.

### Signal Transmission/Reception Method in Wireless Communication System

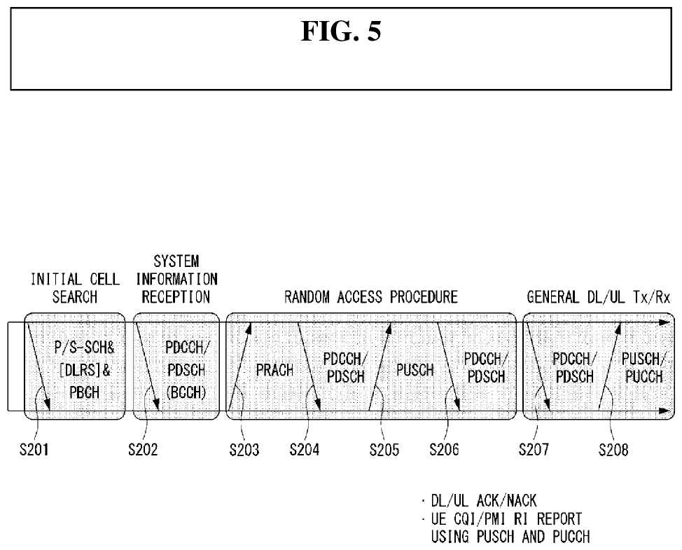

FIG. 5 is a diagram showing an example of a signal transmission/reception method in a wireless communication system. Referring to FIG. 5, when power of a UE is newly turned on or the UE newly enters a cell, the UE performs an initial cell search task, such as performing synchronization with a BS (S501). To this end, the UE may receive a primary synchronization channel (P-SCH) and a secondary synchronization channel (S-SCH) from the BS, may perform synchronization with the BS, and may obtain information, such as a cell ID. In the LTE system and NR system, the P-SCH and the S-SCH are called a primary synchronization signal (PSS) and a secondary synchronization signal (SSS), respectively. After the initial cell search, the UE may obtain broadcast information within the cell by receiving a physical broadcast channel PBCH) form the BS. Meanwhile, the UE may identify a DL channel state by receiving a downlink reference signal (DL RS) in the initial cell search step. After the initial cell search is terminated, the UE may obtain more detailed system information by receiving a physical downlink control channel (PDCCH) and a physical downlink shared channel (PDSCH) based on information carried on the PDCCH (S502).

Meanwhile, if the UE first accesses the BS or does not have a radio resource for signal transmission, the UE may perform a random access procedure (RACH) on the BS (steps S503 to step S506). To this end, the UE may transmit a specific sequence as a preamble through a physical random access channel (PRACH) (S503 and S505), and may receive a random access response (RAR) message for the preamble through a PDSCH corresponding to a PDCCH (S504 and S506). In the case of a contention-based RACH, a contention resolution procedure may be additionally performed.

The UE that has performed the procedure may perform PDCCH/PDSCH reception (S507) and physical uplink shared channel (PUSCH)/physical uplink control channel (PUCCH) transmission (S508) as common uplink/downlink signal transmission processes. In particular, the UE receives downlink control information (DCI) through the PDCCH. The UE monitors a set of PDCCH candidates in monitoring occasions configured in one or more control element sets (CORESETs) on a serving cell based on corresponding search space configurations. A set of PDCCH candidates to be monitored by the UE is defined in the plane of search space sets. The search space set may be a common search space set or a UE-specific search space set. The CORESET is configured with a set of (physical) resource blocks having time duration of 1˜3 OFDM symbols. A network may be configured so that the UE has a plurality of CORESETs. The UE monitors PDCCH candidates within one or more search space sets. In this case, the monitoring means that the UE attempts decoding on a PDCCH candidate(s) within the search space. If the UE is successful in the decoding of one of the PDCCH candidates within the search space, the UE determines that it has detected a PDCCH in a corresponding PDCCH candidate, and performs PDSCH reception or PUSCH transmission based on DCI within the detected PDCCH. The PDCCH may be used to schedule DL transmissions on the PDSCH and UL transmissions on the PUSCH. In this case, the DCI on the PDCCH includes downlink assignment (i.e., downlink (DL) grant) related to a downlink shared channel and at least including a modulation and coding format and resource allocation information, or an uplink (DL) grant related to an uplink shared channel and including a modulation and coding format and resource allocation information.

An initial access (IA) procedure in a 5G communication system is additionally described with reference to FIG. 5. A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described. SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5. A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

### Beam Management (BM) Procedure of 5G Communication System

A BM process may be divided into (1) a DL BM process using an SSB or CSI-RS and (2) an UL BM process using a sounding reference signal (SRS). Furthermore, each BM process may include Tx beam sweeping for determining a Tx beam and Rx beam sweeping for determining an Rx beam.

A DL BM process using an SSB is described. The configuration of beam reporting using an SSB is performed when a channel state information (CSI)/beam configuration is performed in RRC_CONNECTED.
A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.
The UE receives signals on the SSB resources from the BS based on the CSI-SSB-ResourceSetList.
If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described.

An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described.
The UE receives an NZP CSI-RS resource set IE, including an RRC parameter regarding “repetition”, from a BS through RRC signaling. In this case, the RRC parameter “repetition” has been set as “ON.”
The UE repeatedly receives signals on a resource(s) within a CSI-RS resource set in which the RRC parameter “repetition” has been set as “ON” in different OFDM symbols through the same Tx beam (or DL spatial domain transmission filter) of the BS.
The UE determines its own Rx beam.
The UE omits CSI reporting. That is, if the RRC parameter “repetition” has been set as “ON”, the UE may omit CSI reporting.

Next, the Tx beam determination process of a BS is described.—A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.
The UE receives signals on resources within a CSI-RS resource set in which the RRC parameter “repetition” has been set as “OFF” through different Tx beams (DL spatial domain transmission filter) of the BS.
The UE selects (or determines) the best beam.
The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described.
A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.
The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.
If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described.

In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-Reliable and Low Latency Communication (URLLC)

URLLC transmission defined in NR may mean transmission for (1) a relatively low traffic size, (2) a relatively low arrival rate, (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. eMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by position In DCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE. When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be an UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH.

That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

Robot Basic Operation Using 5G Communication

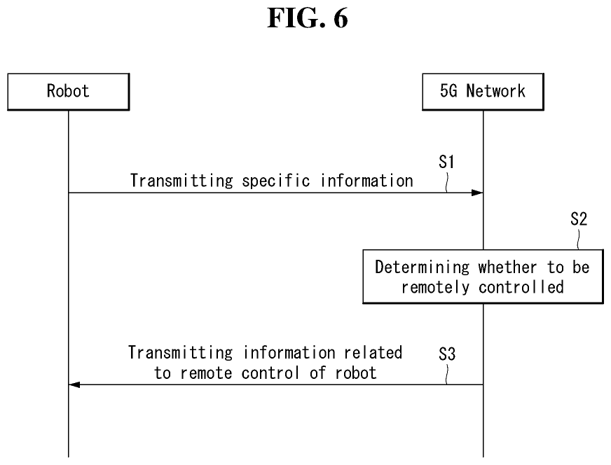

FIG. 6 shows an example of a basic operation of the robot and a 5G network in a 5G communication system. A robot transmits specific information transmission to a 5G network (S1). Furthermore, the 5G network may determine whether the robot is remotely controlled (S2). In this case, the 5G network may include a server or module for performing robot-related remote control. Furthermore, the 5G network may transmit, to the robot, information (or signal) related to the remote control of the robot (S3).

Application Operation Between Robot and 5G Network in 5G Communication System

Hereafter, a robot operation using 5G communication is described more specifically with reference to FIGS. 1 to 6 and the above-described wireless communication technology (BM procedure, URLLC, mMTC).

A basic procedure of a method to be proposed in the present disclosure and an application operation to which the eMBB technology of 5G communication is applied is described.

As in steps S1 and S3 of FIG. 6, in order for a robot to transmit/receive a signal, information, etc. to/from a 5G network, the robot performs an initial access procedure and a random access procedure along with a 5G network prior to step S1 of FIG. 6.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed in the present disclosure and an application operation to which the URLLC technology of 5G communication is applied is described below.

As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed in the present disclosure and an application operation to which the mMTC technology of 5G communication is applied is described below.

A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

Operation Between Robots Using 5G Communication

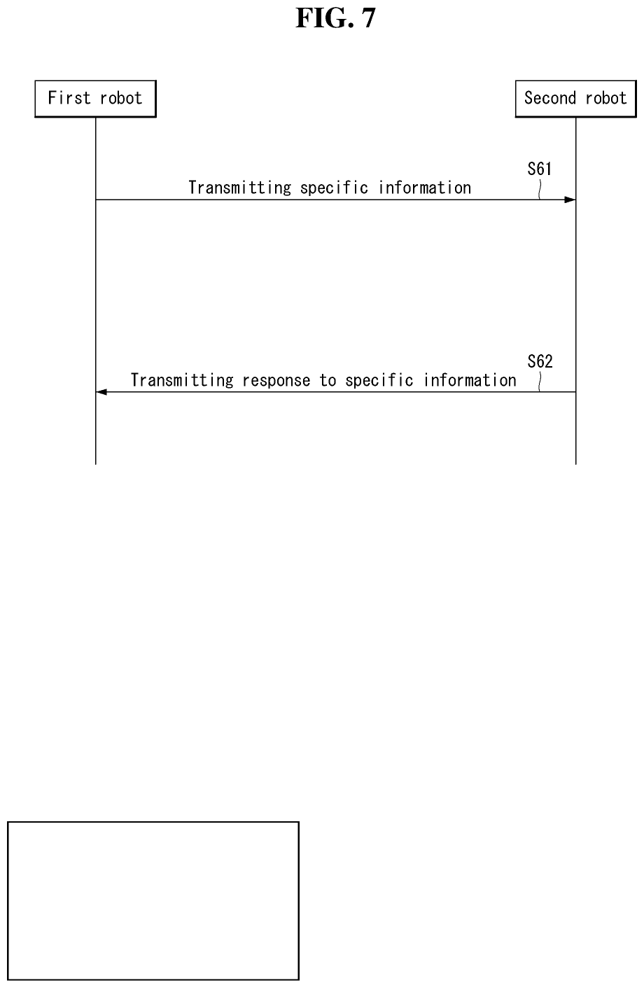

FIG. 7 illustrates an example of a basic operation between robots using 5G communication. A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below. A method for a 5G network to be directly involved in the resource allocation of signal transmission/reception between robots is described.

The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below.

A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in embodiments of the present disclosure, and may be applied or may be supplemented to materialize or clarify the technical characteristics of methods proposed in embodiments of the present disclosure.

Drone

Unmanned aerial system: a combination of a UAV and a UAV controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

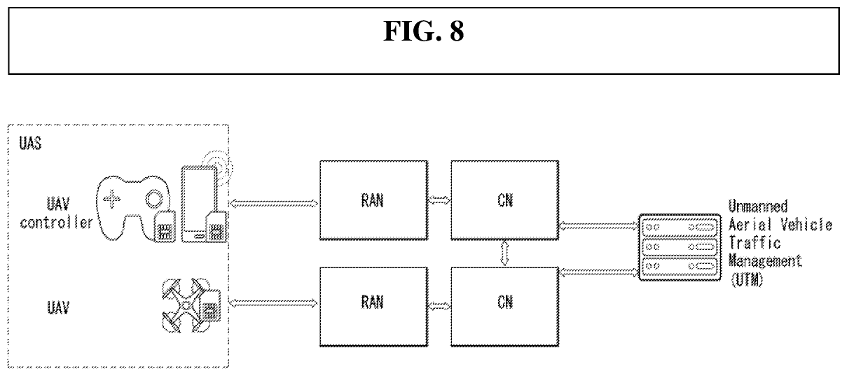

FIG. 8 is a diagram showing an example of the concept diagram of a 3GPP system including a UAS. An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows.
A 3GPP system enables the UAS to transmit different UAS data to UTM based on different certification and an authority level applied to the UAS.
A 3GPP system supports a function of expanding UAS data transmitted to UTM along with future UTM and the evolution of a support application.
A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.
A 3GPP system enables the UE of a UAS to transmit an identity, such as an IMEI, MSISDN or IMSI or IP address, to UTM.
A 3GPP system enables a mobile network operator (MNO) to supplement data transmitted to UTM, along with network-based location information of a UAV and a UAV controller.
A 3GPP system enables MNO to be notified of a result of permission so that UTM operates.
A 3GPP system enables MNO to permit a UAS certification request only when proper subscription information is present.
A 3GPP system provides the ID(s) of a UAS to UTM.
A 3GPP system enables a UAS to update UTM with live location information of a UAV and a UAV controller.
A 3GPP system provides UTM with supplement location information of a UAV and a UAV controller.
A 3GPP system supports UAVs, and corresponding UAV controllers are connected to other PLMNs at the same time.
A 3GPP system provides a function for enabling the corresponding system to obtain UAS information on the support of a 3GPP communication capability designed for a UAS operation.
A 3GPP system supports UAS identification and subscription data capable of distinguishing between a UAS having a UAS capable UE and a USA having a non-UAS capable UE.
A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

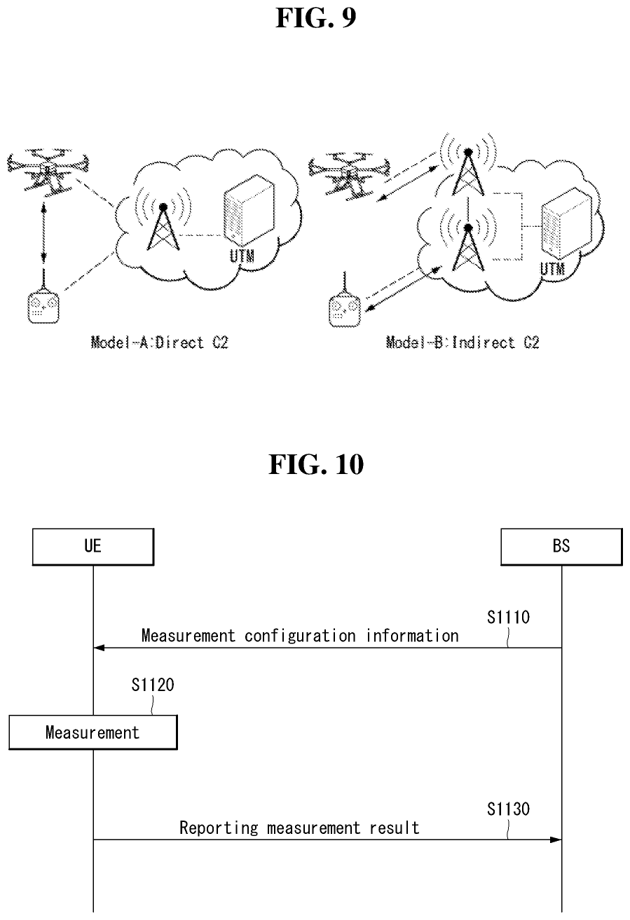

FIG. 9 shows examples of a C2 communication model for a UAV. Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV Traffic Management

(1) Centralized UAV Traffic Management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-Centralized UAV Traffic Management
A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.
A 3GPP system supports a UAV in order to transmit a message through a network connection for identification between different UAVs. The UAV preserves owner's personal information of a UAV, UAV pilot and UAV operator in the broadcasting of identity information.
A 3GPP system enables a UAV to receive local broadcasting communication transmission service from another UAV in a short distance.
A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.
A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.
A 3GPP system supports the direct UAV versus UAV local broadcast communication transmission service capable of guaranteeing separation between UAVs. In this case, the UAVs may be considered to have been separated if they are in a horizontal distance of at least 50 m or a vertical distance of 30 m or both. The 3GPP system supports the direct UAV versus UAV local broadcast communication transmission service that supports the range of a maximum of 600 m.
A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms.
A UAV may broadcast its own identity locally at least once per second, and may locally broadcast its own identity up to a 500 m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP Support for Aerial UE (or Drone) Communication

An E-UTRAN-based mechanism that provides an LTE connection to a UE capable of aerial communication is supported through the following functions.
Subscription-based aerial UE identification and authorization defined in Section TS 23.401, 4.3.31.
Height reporting based on an event in which the altitude of a UE exceeds a reference altitude threshold configured with a network.
Interference detection based on measurement reporting triggered when the number of configured cells (i.e., greater than 1) satisfies a triggering criterion at the same time.
Signaling of flight route information from a UE to an E-UTRAN.
Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference Detection and Mitigation for Aerial UE Communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting.

Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents.
UE-specific partial pathloss compensation factor
UE-specific Po parameter
Neighbor cell interference control parameter
Closed-loop power control

The power control-based mechanism for UL interference mitigation is described more specifically.

1) UE-specific partial pathloss compensation factor

The enhancement of the existing open-loop power control mechanism is taken into consideration in the place where a UE-specific partial pathloss compensation factor α_{UE} is introduced. Due to the introduction of the UE-specific partial pathloss compensation factor α_{UE}, different α_{UE} may be configured by comparing an aerial UE with a partial pathloss compensation factor configured in a terrestrial UE.

2) UE-Specific PO Parameter

Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor α_{UE} and the UE-specific Po may be used in common for uplink interference mitigation. Accordingly, the UE-specific partial path loss compensation factor α_{UE} and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.
Improvement of a handover procedure for an aerial UE and/or mobility of a handover-related parameter based on location information and information, such as the aerial state of a UE and a flight route plan
A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

A measurement execution method which may be applied to an aerial UE is described more specifically.

FIG. 10 is a flowchart showing an example of a measurement execution method to which the present disclosure may be applied. An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of a RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2.

Event H1 (Aerial UE Height Exceeding a Threshold)

A UE considers that an entering condition for the event is satisfied when 1) the following defined condition H1-1 is satisfied, and considers that a leaving condition for the event is satisfied when 2) the following defined condition H1-2 is satisfied.

Inequality H1-1 (entering condition): Ms−Hys>Thresh+Offset

Inequality H1-2 (leaving condition): Ms+Hys<Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Inequality H2-1 (entering condition): Ms+Hys<Thresh+Offset

Inequality H2-2 (leaving condition): Ms−Hys>Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on about a parameter for configuration of measurement unit, reporting unit and/or filtering of measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1

| | |
|---|---|
| -- ASN1START.....MeasParameters-v1530 ::= | SEQUENCE {qoe- |

MeasReport-r15

ENUMERATED {supported}OPTIONAL, qoe-MTSI-MeasReport-r15
ENUMERATED {supported}OPTIONAL, ca-IdleModeMeasurements-r15
ENUMERATED {supported} OPTIONAL, ca-IdleModeValidityArea-r15
ENUMERATED {supported} OPTIONAL, heightMeas-r15 ENUMERATED

| | |
|---|---|
| {supported} | OPTIONAL, multipleCellsMeasExtension-r15 ENUMERATED |

| | |
|---|---|
| {supported} | OPTIONAL}..... |

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling.

In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling.

In the case of X2-based handover, aerial UE subscription information of a user is transmitted to a target BS as follows:
If a source BS supports the aerial UE function and aerial UE subscription information of a user is included in UE context, the source BS includes corresponding information in the X2-AP handover request message of a target BS.
An MME transmits, to the target BS, the aerial UE subscription information in a Path Switch Request Acknowledge message.

An object of a handover resource allocation procedure is to secure, by a target BS, a resource for the handover of a UE.

If aerial UE subscription information is changed, updated aerial UE subscription information is included in an S1-AP UE context modification request message transmitted to a BS.

Table 2 is a table showing an example of the aerial UE subscription information.

TABLE 2

| | | | |
|---|---|---|---|
| IE/Group Name | Presence | Range | IE type and reference |

| | | |
|---|---|---|
| Aerial UE | M | ENUMERATED (allowed, |
| subscription | | not allowed, . . .) |
| information | | |

Aerial UE subscription information is used by a BS in order to know whether a UE can use the aerial UE function.

Combination of Drone and eMBB

A 3GPP system can support data transmission for a UAV (aerial UE or drone) and for an eMBB user at the same time.

A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

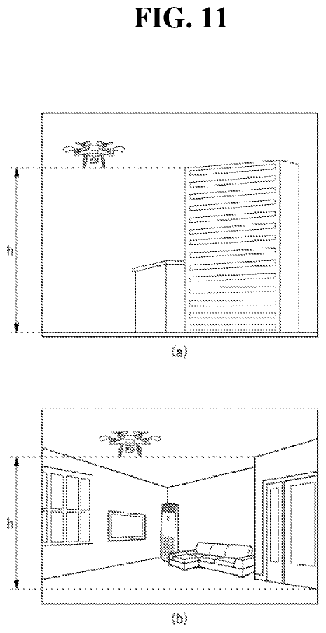

FIG. 11 briefly shows an example of an altitude measuring method using a drone. Referring to FIG. 11, (a) a height of a building may be measured by measuring an altitude of a drone flying outdoors, and (b) an interior of the building may be modeled in detail by measuring an inside of the building using a drone flying indoors.

Specifically, (a) it is necessary to accurately measure the height of the building being built at a stage of building the building, and it is necessary to measure the height of the building even after the building is built. For example, at the stage of building the building, it is necessary to build the building while accurately measuring the height of the building in order to make the height of each floor constant.

In this case, if a person directly measures the height of the building, there is a risk of falling, and the measured value may vary depending on the individual. However, in the case of using a drone, the height of the building may be accurately and safely measured by moving the drone to a desired location and measuring the altitude of the drone.

In addition, (b) In order to model the interior structure of a building, drones can also be used to measure the height of a room. When using a drone, the drone flies quickly and moves to the detailed place of the building to accurately measure the height of the building, so you can model the internal structure faster and more accurately than a person would.

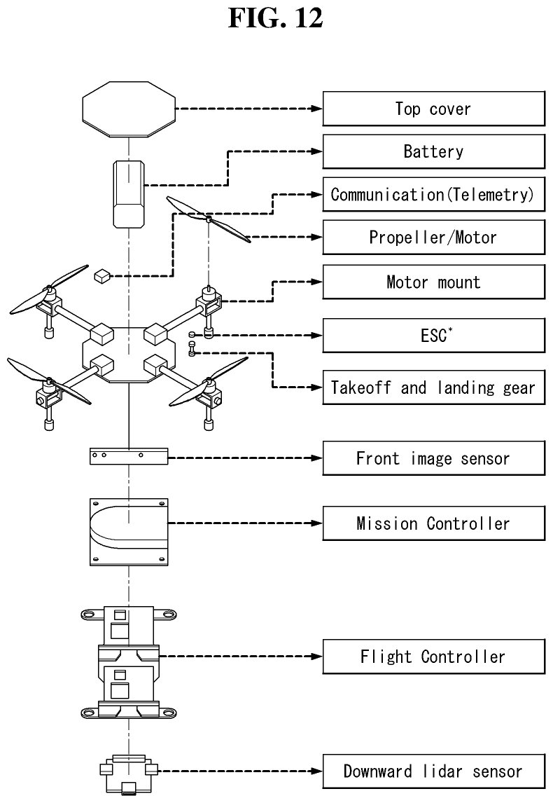

FIG. 12 shows a specific structure of a drone for measuring an altitude according to an embodiment of the present disclosure. A drone for measuring an altitude according to the present disclosure may include a top cover, a battery, a communication unit (or transceiver), a propeller, a motor, a motor mount, an electronic speed control (ESC), a takeoff and landing gear, a front image sensor, and a mission controller, a flight controller, and a downward lidar sensor.

The ESC is a device for controlling the speed of the drone, and can control the speed of each motor to balance the drone or enable movement such as rotation. The ESC may be provided for each motor, and in this case, the motors may be individually controlled.

In addition to the devices shown in FIG. 12, the drone may include a plurality of light sources and cameras for measuring an altitude. The plurality of light sources may generate light with directionality to the ground, and the generated light may be used to measure the altitude of the drone.

For example, when a laser beam generated from two light sources is generated on the ground, by measuring a distance between the laser beams generated to the ground, and calculating a length of the ground for height measurement based on the measured distance, a length of a vertical height from the ground to the drone may be calculated (or determined).

In order to measure the length of the ground, a specific mark can be displayed on the ground so that it can be calculated based on the length between the laser beams. In addition, the length of the straight line can be calculated by comparing the length between the laser beams and the length of a straight line including two laser beams from image information photographed with the camera.

When the length of the ground is calculated, the drone can calculate the vertical height from the ground to the drone using the length and angle of the ground. For example, measure (or calculate) an angle between the drone and one end of the length of the ground or an angle between the laser beam and the ground (or vertical height). Based on the calculated angle and a length from a position (vertical position) of the ground perpendicular to the drone to the one end of the length of the ground, the vertical height of the drone can be calculated. The length from the vertical position to the one end of the length of the ground may be half of the length of the ground.

A method for calculating the vertical height of the drone will be described in detail.

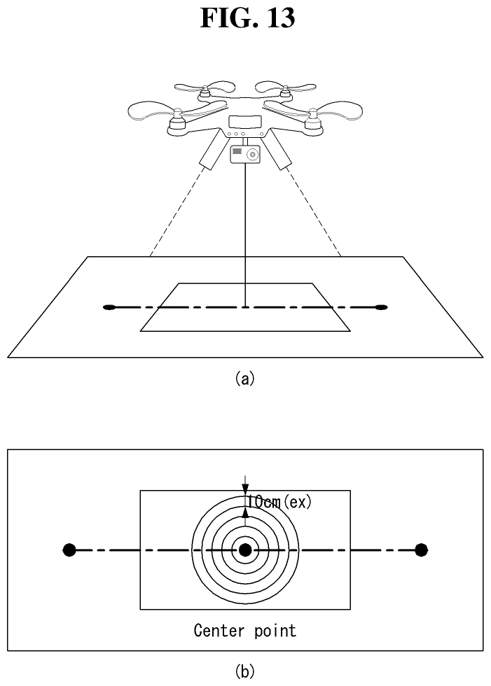

FIG. 13 shows an example of a method for measuring an altitude of a drone according to an embodiment of the present disclosure. The drone may calculate the vertical height between the drone and the ground by measuring the distance between the laser beams generated from the plurality of light sources in order to calculate the vertical height.

Specifically, as shown in (a) of FIG. 13, the drone can calculate (or determine) the height h between the drone and the ground using an actual distance W between points where the laser beam generated from the plurality of light sources reaches the ground, and at least one of an angle (θ) between the vertical line between the drone and the ground and one laser beam or an angle between the laser beams (Field of view angle of camera: FOV).

At this time, the angle θ is a value between 0 and 90 degrees as shown in Equation 1 below, and may be calculated using the angle (FOV) between the laser beams from 0 degrees.

$${0}^{°} < θ \leq {90}^{°} , {0}^{°} < θ \leq \frac{FOV}{2} \qquad [ Equation 1 ]$$

The actual distance W means a distance between points where the laser beams generated from the plurality of light sources reaches the ground. The actual distance W may be calculated based on a reference drawing attached or marked on the ground.

The reference drawing may be formed as a center line (point) and a reference line, as shown in (b) of FIG. 13, and the drone may recognize the reference drawing by capturing image of the reference drawing through the camera.

The reference line may be formed at a regular distance from the center point. For example, in (b) of FIG. 13, the reference line is formed at a distance of 10 cm from the center point.

The drone matches the center point of the recognized reference drawing with the position of the drone, and measures a distance from the center point to the point where one laser beam hits. Thereafter, a substantive distance or an actual distance W from the center point to the point where one laser beam hits may be calculated by comparing the measured distance with the reference line.

For example, when the distance between two points where the laser beam hits the ground is a specific multiple of a distance of the reference lines, the actual distance W may be calculated by multiplying the specific multiple by the distance between the reference lines.

When the drone acquires the actual distance W and the angle θ, the vertical height h between the ground and the drone may be calculated using the acquired actual distance W and angle θ. For example, the drone may calculate the vertical height h through Equation 2 below.

$$h = \frac{w}{2} * {tan}^{- 1} θ \qquad [ Equation 2 ]$$

In Equation 2, when the value of the angle θ is 45 degrees, the vertical height h may be calculated as half of the actual distance w.

In FIG. 13(b), the reference drawing is illustrated in a circle, but this is only an example, and the reference drawing may be in various forms for calculating an actual distance between two points.

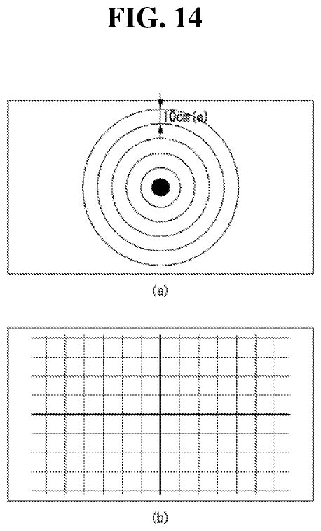

FIG. 14 shows an example of a reference drawing for measuring an altitude of a drone according to an embodiment of the present disclosure. A reference drawing is (a) a plurality of reference lines are formed in a circular shape at a regular distance around a reference point, or (b) the reference line is formed as x-axis and y-axis, a plurality of reference lines may be formed at a regular distance so as to be symmetric to each reference line.

The reference drawings shown in (a) and (b) of FIG. 14 may be effective under specific conditions, respectively, and may be used under different conditions depending on the case.

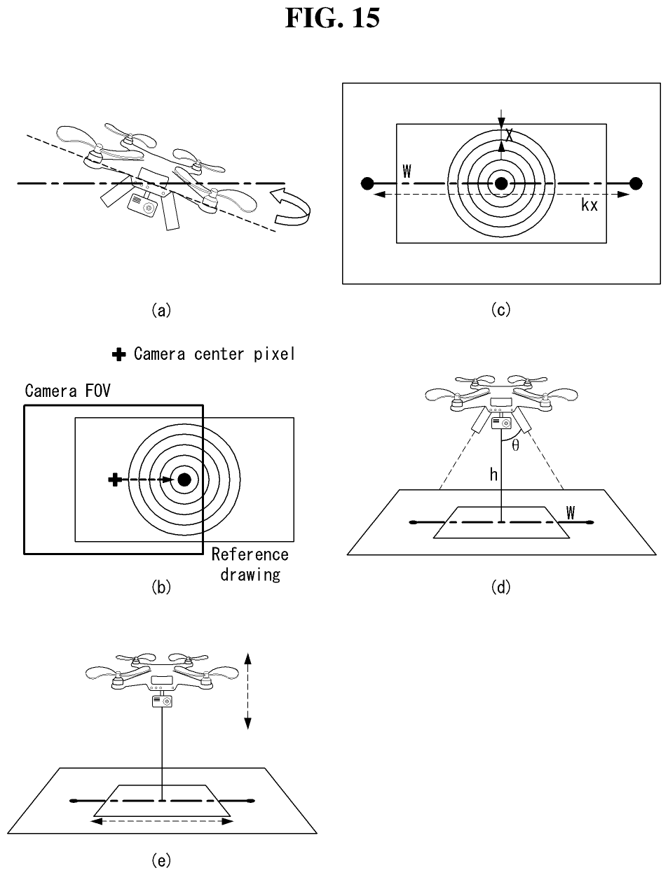

FIG. 15 shows a specific example of a method for measuring an altitude of a drone according to an embodiment of the present disclosure. The drone may calculate a height between the drone and the ground by using a distance and an angle formed through a plurality of laser beams generated from a plurality of light sources.

Specifically, (a) the drone maintains the drone's posture by adjusting the drone's posture to be horizontal in order to measure or calculate the vertical height h value from the ground to the drone.

If the drone's posture is not level with the ground, a distance from each position of the drone to the ground is not constant, and a distance that the laser beam generated from the light source hits the ground becomes irregular, so that it is difficult to accurately measure the vertical height h of the drone. Therefore, the drone may maintain the horizontal posture after adjusting the posture of the drone to be level with the ground using a sensor for adjusting the level with the ground.

As shown in (b), thereafter, the center point or center line of the reference drawing marked or attached to the ground is matched with a camera center pixel of the drone. The reference drawing may be used to calculate the actual distance of the ground captured through the camera or the laser beam generated from the light source, and various types of reference drawing may be used as shown in FIG. 14.

As shown in (c), the drone may calculate the value of the actual distance w of the distance, which is the length between the points where the laser beam reaches the ground, through the distance between the reference lines in the reference drawing. That is, after calculating whether the value of w is an integer multiple k of the distance x between the reference lines, the value of w may be calculated by multiplying the value of x by k.

As shown in (d), the drone may calculate the height h through Equation 2 or Equation 3 below using the relationship between w and height h using the value w and the angle θ value.

w_{d}=h_{d}*tan(θ) [Equation 3]

In Equation 3, wd and hd mean actual distances to w and h.

As shown in (e), thereafter, after calculating a current height of the drone, the drone compares a target height with the current height, if the target height and the current height are different, the altitude may be adjusted.

At this time, the adjustment of the altitude to the target height may be performed by repeating the processes of (c) and (d).

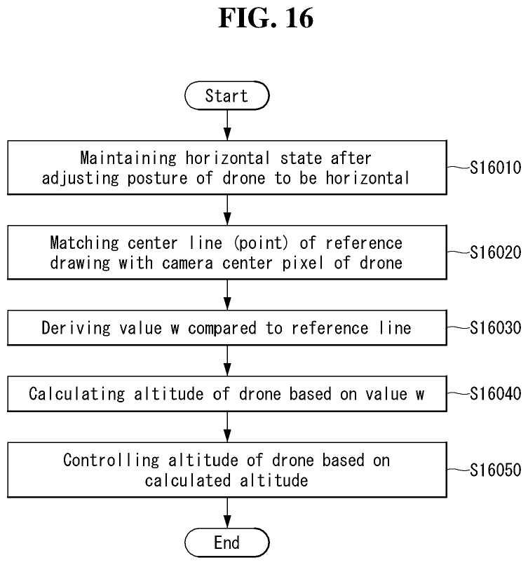

FIG. 16 is a flowchart illustrating a specific example of a method for measuring an altitude of a drone according to an embodiment of the present disclosure. The drone maintains a horizontal state after adjusting the posture of the drone to be horizontal in order to measure or calculate the vertical height h value from the ground to the drone (S16010).

That is, the drone determines whether the current drone is level with the ground through a sensor capable of recognizing a horizontal state, such as a gyro sensor. In addition, after generating a plurality of light sources to the ground, the distance to the ground is calculated, and the calculated distances are compared to determine that the drone is in horizontal state if all distances are equal.

However, if the calculated distances are not all the same, it is determined that the drone is not level with the ground, and the horizontal state of the drone may be adjusted by adjusting the distance to the ground by the rest of the laser beams based on the specific laser beam to be equal to the distance by the specific laser beam.

Thereafter, the drone matches the center point or center line of the reference drawing marked or attached to the ground with the camera center pixel of the drone (S16020). The reference drawing may be used to calculate the actual distance of the ground captured through the camera or the laser beam generated from the light source, and various types of reference drawings may be used as shown in FIG. 14.

For example, when the reference drawing is circular as shown in FIG. 14 (a), the drone may match the center pixel of the camera with the center point of the reference drawing.

When the drone recognizes that the center pixel of the camera matches the center point or center line of the reference drawing, the drone may derive the value of the actual distance w of the distance, which is the length between the points where the laser beam reaches the ground, through the distance between the reference lines in the reference drawing (S16030). That is, after calculating whether the value of w is an integer multiple k of the distance x between the reference lines, the value of w may be calculated by multiplying the value of x by k.

The drone may acquire the angle θ through the method described in FIGS. 13 to 15, and calculate the height h through Equation 2 or Equation 3 using the relationship between w and height h using the value w and the angle θ value (S16040).

That is, the drone acquires an angle FOV value between laser beams generated through a plurality of light sources, divides the acquired FOV value by 2 to calculate the angle (θ) value, or calculate an angle between a straight line from the center pixel of the camera to the center point of the reference drawing and a straight line by the laser beam, so that the drone may calculate the angle (θ) value.

Thereafter, the drone may calculate the current height, and then control the altitude based on the altitude, which is the calculated current height. For example, after comparing a target height with the current height, if the target height and the current height are different, the drone may adjust the altitude. At this time, the adjustment of the altitude to the target height may be adjusted by repeatedly performing steps S16030 and S16040.

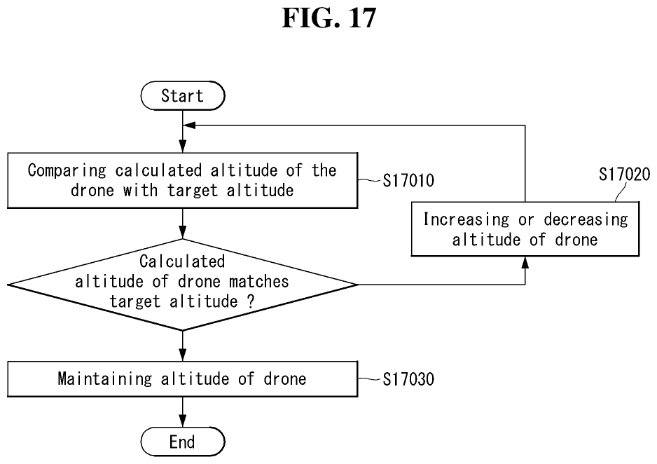

FIG. 17 is a flowchart illustrating an example of a method for controlling an altitude of a drone according to an embodiment of the present disclosure. The drone may calculate the height of the current drone, and then control the height of the drone based on the calculated height.

Specifically, the drone calculates the current height through the method described in FIG. 16, and then compares the calculated current altitude with the target altitude of the drone (S17010).

At this time, the target altitude is inputted by the user, so that the drone can acquire it, or when a specific event or a specific target is set, the drone may decide based on this.

For example, in order to measure the indoor interior structure, the drone may calculate the height optimized for the measurement in consideration of the indoor height and set it as the target altitude when the goal of indoor interior measurement is set.

If the calculated altitude of the drone does not match the target altitude, the drone may increase or decrease the altitude (S17020).

Thereafter, the drone may control the altitude of the drone so that the altitude of the drone is the same as the target altitude or within an error range by repeatedly performing the method described in FIG. 16.

The drone may fly by maintaining the altitude of the drone when the calculated altitude of the drone and the target altitude are the same or within the error range (S17030). At this time, the drone may provide a specific service to the user by performing a specific event or a specific target while flying.

Through this method, the drone may calculate the current altitude, and may adjust and control the altitude depending on the calculated altitude and the event or mission that occurred to the drone.

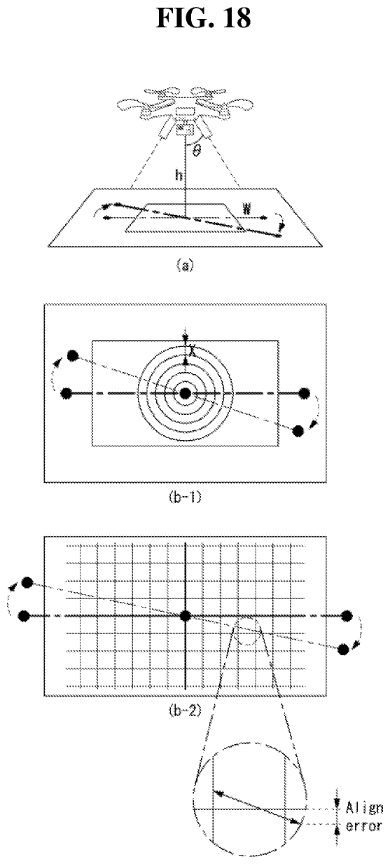

FIG. 18 shows an example of an error that may occur according to a reference drawing according to an embodiment of the present disclosure. Referring to (a) of FIG. 18, a reference drawing may be used on the ground to calculate an actual length w of the ground in order for the drone to calculate the height h. In this case, an error may occur depending on a shape of the reference drawing.

For example, as shown in (b-1) of FIG. 18, when the drone uses a circular drawing as a reference drawing, as the drone rotates to left or right, even if the actual length w rotates, an align error does not occur, and the value of w may be clearly measured.

However, when using a reference drawing in a square shape as shown in (b-2) of FIG. 18, as the drone rotates left or right, a straight line distance w between the laser beams does not match the center line and reference lines in the reference drawing. In this case, it is difficult to clearly measure the value of w, and thus the height of the drone may not be accurately calculated.

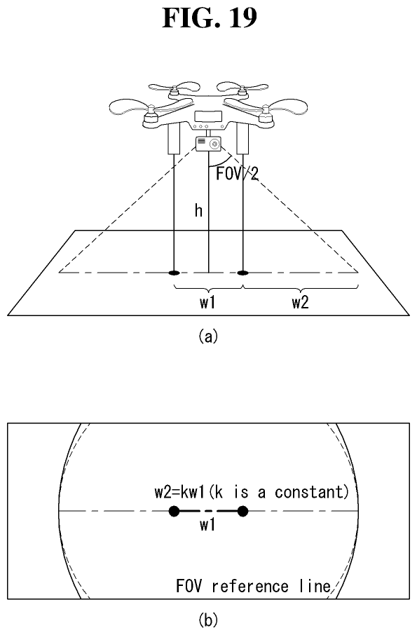

FIG. 19 shows another example of a method for measuring an altitude of a drone according to an embodiment of the present disclosure. The height of the drone may be calculated based on image information acquired through the camera of the drone instead of the reference drawing.

Specifically, as shown in (a) of FIG. 19, the drone adjusts the posture to be level with the ground, and then captures image of the ground through a camera to acquire image information of the ground. At this time, the image information may be a circular image as shown in (b) of FIG. 19.

Thereafter, the drone may calculate a straight line distance from one end of an area included in a shooting range depending on a view angle of the camera to the other end. For example, when the shooting range of the ground depending on the view angle of the camera of the drone is circular, the drone may calculate the diameter of the circular shooting range. In this case, the drone may generate two laser beams perpendicular to the ground through light sources on the diameter of the shooting range, and calculate the diameter of the shooting range or a value of W2 using a distance W1 between the two laser beams. That is, the value of W2 may be measured or calculated relatively through W1.

At this time, the distance W1 between the laser beams may be a value that the drone already knows or set or promised in advance. Further, the captured ground through the camera may be a flat area without bending.

The drone may calculate the value of W2 by comparing the distance W1 between the beams and W2, as shown in (b) of FIG. 19. That is, by comparing W2 and W1, and recognizing that W2 is a ‘k’ times W1 (k is a constant), the drone may calculate the value of W2 because the value of W1 is already known.

Thereafter, the drone acquires an angle θ for acquiring a height by dividing the FOV value, which is the view angle of the camera, by 2. At this time, the view angle of the camera is an angle value according to the setting of the camera, and the drone may already recognize it.

Thereafter, the drone may calculate the height h of the drone according to Equation 3 below based on the calculated distance of the ground and the angle.

$$h = {tan}^{- 1} ( \frac{{w}_{1}}{2} + {w}_{2} ) \qquad [ Equation 3 ]$$

At this time, when calculating the height of the drone indoors, it may be used to calculate the height of the drone at high floors by utilizing a narrow field of view angle (FOV), the height of the drone can be calculated by using a narrow angle of view through the camera's aperture or software (for example, post-processing of images, etc.).

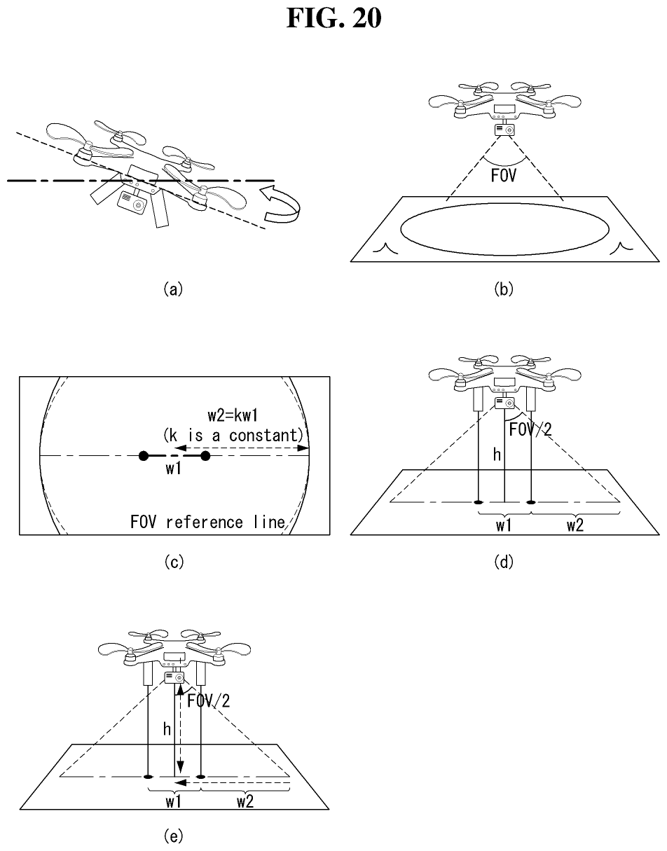

FIG. 20 shows another specific example of a method for measuring an altitude of a drone according to an embodiment of the present disclosure. The drone may calculate the current height of the drone using a captured image of the ground through the camera and a laser beam generated through a plurality of light sources.

Specifically, as shown in (a) the drone maintains the drone's posture by adjusting the drone's posture to be horizontal in order to measure or calculate the vertical height h value from the ground to the drone.

If the drone's posture is not level with the ground, a distance from each position of the drone to the ground is not constant, and the distance that the laser beam from the light source hits the ground becomes irregular, so that it is difficult to accurately measure the vertical height h of the drone. Therefore, the drone may maintain the horizontal posture after adjusting the posture of the drone to be level with the ground using a sensor for adjusting the level with the ground.

As shown in (b), thereafter, the drone may check whether the ground is flat through the camera. That is, in order for the drone to measure the height of the drone using the generation of the laser beam through the light source, the ground must be flat. That is, if the ground is non-uniform, the distortion of the length of the laser beam or the video image of the camera may occur, so that the height of the drone cannot be accurately measured.

As shown in (c), the drone may generate two laser beams perpendicular to the ground through a light source on a diameter of a shooting range on the ground when the ground is flat, as described in FIG. 19, and calculate the diameter of the shooting range or the value of W2 using the distance W1 between two laser beams.

The drone may calculate the W1/2+W2 value, which is the radius value of the shooting range, to calculate the height using the calculated W2 value or diameter.

At this time, the distance W1 between the laser beams may be a value that the drone already knows or set or promised in advance.

As shown in (d), the drone may measure or calculate the altitude of the drone using Equation 3 using the acquired radius and the angle θ, which is half of the view angle of the camera.

As shown in (e), thereafter, after calculating a current height of the drone, the drone compares a target height with the current height, if the target height and the current height are different, the altitude may be adjusted.

At this time, the adjustment of the altitude to the target height may be performed by repeating the processes of (c) and (d).

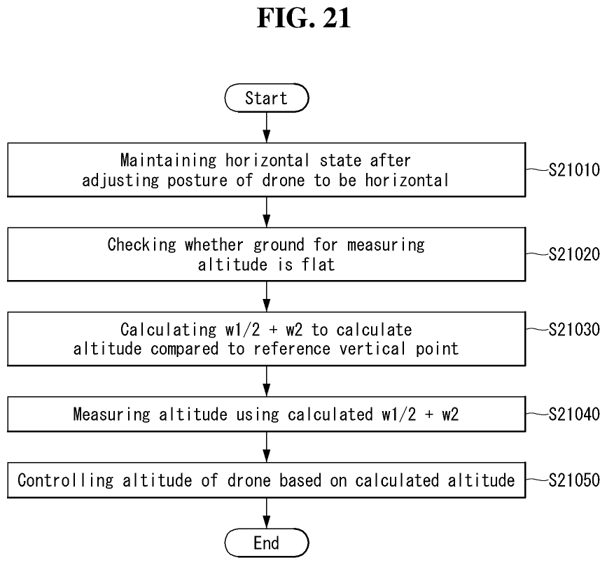

FIG. 21 is a flowchart illustrating another specific example of a method for measuring an altitude of a drone according to an embodiment of the present disclosure. The drone maintains a horizontal state after adjusting the posture of the drone to be horizontal in order to measure or calculate the vertical height h value from the ground to the drone (S21010). That is, the drone determines whether the current drone is level with the ground through a sensor capable of recognizing a horizontal state, such as a gyro sensor. In addition, after generation a plurality of light sources to the ground, the distance to the ground is calculated, and the calculated distances are compared to determine that the drone is in horizontal state if all distances equal. However, if the calculated distances are not all the same, it is determined that the drone is not level with the ground, and the horizontal state of the drone may be adjusted by adjusting the distance to the ground by the rest of the laser beams based on the specific laser beam to be equal to the distance by the specific laser beam.

The drone captures image of the ground through the camera when it is in a horizontal state and checks whether the ground state is a flat state without bending (S21020). If the ground is curved or uneven, the state of the ground must be flat in order for the drone to calculate the height of the drone by capturing image of the ground through the camera because errors may occur in the values that the drone acquires to calculate the height. If the state of the ground acquired through the camera is uneven and curved, the drone may move to a flat surface.

Thereafter, the drone may generate the laser beam through the plurality of light sources to the ground, compare the reference vertical point w1 of the generated laser beams with w2 for the shooting range through the camera, and calculate w1/2+w2 (S21030).

That is, by comparing w1 with w2 relatively, if it is confirmed that w2 has a difference of an integer multiple relative to w1, nd w1/2+w2 may be calculated by multiplying W1, which has already been set or promised and the drone knows, by an integer value that is a multiple of W2.

In addition, the drone may know an angle (θ) between the vertical height of the drone and the ground for acquiring the height using the view angle of the camera and the straight line to one end of the shooting range. That is, half of the view angle is an angle θ value.

Using the calculated w1/2+w2 and the angle θ, the drone may measure or calculate the height (altitude) of the drone using a trigonometric function such as Equation 3 (S21040).

Thereafter, the drone may calculate the current height, and then control the altitude based on the altitude, which is the calculated current height (S21050). For example, after comparing the target height with the current height, the drone may adjust the altitude when the target height and the current height are different. At this time, the adjustment of the altitude to the target height may be adjusted by repeatedly performing steps S21030 and S21040.

At this time, the drone may control the altitude through the method described in FIG. 17.

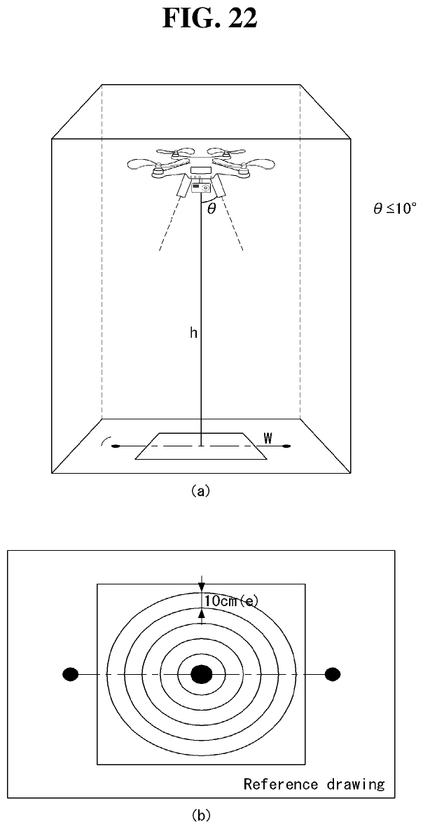

FIG. 22 shows an example of a method for measuring an altitude of a drone indoors according to an embodiment of the present disclosure. The drone may calculate the altitude through the method described above in FIGS. 13 to 21. At this time, the drone may measure the height of the drone using a narrow view angle when the view angle is small (for example, 10 degrees or less) as shown in (a) of FIG. 22.

For example, the drone may use the method described in FIGS. 13 to 21 to calculate the height between the drone and the ground inside the elevator. In this case, the view angle of the drone in the elevator has to be reduced in order to capture the image of the ground or a reference drawing of the ground, and the height of the drone may be calculated through the reduced view angle. In this case, the reference drawing may be a circular reference drawing as shown in (b) of FIG. 22 or various reference drawings as described in FIG. 14.

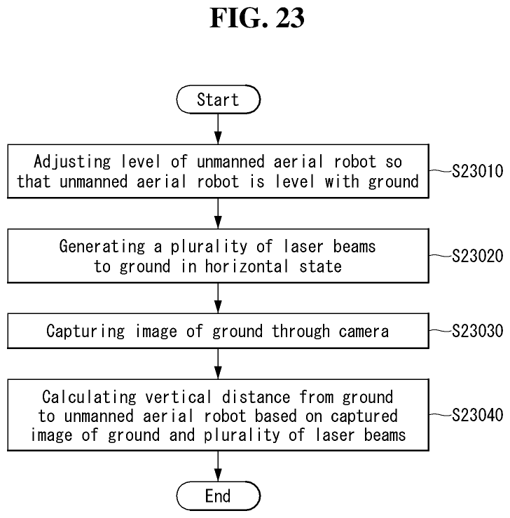

FIG. 23 is a flowchart illustrating an example of an altitude measuring method performed in a drone according to an embodiment of the present disclosure. A drone or an unmanned aerial robot adjusts a level of the unmanned aerial robot so that the unmanned aerial robot is level with the ground (S23010). At this time, the drone determines whether the current drone is level with the ground through a sensor capable of recognizing a horizontal state, such as a gyro sensor. After generation a plurality of light sources to the ground, the distance to the ground is calculated, and the calculated distances are compared to determine that the drone is in horizontal state if all distances equal.

At this time, if the posture of the drone is not level with the ground, the drone may adjust the posture to adjust to a horizontal state, and then maintain the horizontal state. Thereafter, the drone generates a plurality of laser beams to the ground through a plurality of light sources in the horizontal state (S23020).

When calculating the height through the method described in FIGS. 13 to 17, the drone generates a laser beam diagonally, and when calculating the height through the method described in FIGS. 19 to 21, the drone generates a laser beam vertically to the ground.

Thereafter, when calculating the height through the method described in FIGS. 13 to 17, the drone may fit the center pixel of the camera to the reference drawing installed on the ground and calculate the height. However, when the drone calculates the height through the method described in FIGS. 19 to 21, the drone captures image of the ground through the camera to calculate the height based on image information through the camera (S23030).

The drone may calculate a vertical distance from the ground to the unmanned aerial robot based on the captured image of the ground and the plurality of laser beams (S23040).

At this time, the vertical distance that is the height is calculated based on a horizontal ground distance from the position of the unmanned aerial robot on the ground to one end point of the image and a specific angle. The specific angle is an angle between the vertical distance and the distance between the unmanned aerial robot and the one end point of the image, and the ground distance is determined based on a reference distance. For example, as described in FIGS. 19 to 21, the W2 value is calculated based on the reference distance W1 between the laser beams, and the radius value W1/2+W2 for the camera's shooting range may be calculated based on the calculated W1 and W2.

Thereafter, it is possible to calculate the height h through a trigonometric function such as Equation 3 using half the value for the view angle of the camera and W1/2+W2.

After calculating the current height, the drone may perform a specific service or mission by controlling the altitude through the method described in FIGS. 16, 17, and 21, when performing the specific service or mission.

Overview of Devices to which the Present Disclosure can be Applied

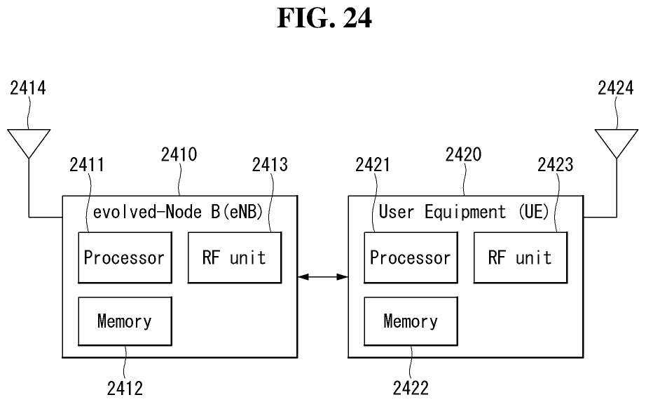

FIG. 24 illustrates a block diagram of a wireless communication device according to an embodiment of the present disclosure. A wireless communication system includes a base station (or network) 2410 and a terminal 2420. The terminal may be a UE, a UAV, a drone, a wireless aerial robot, or the like.

The base station includes a processor 2411, a memory 2412, and a communication module 2413 (or RF unit). The processor 2411 implements the functions, processes and/or methods proposed in FIGS. 1 to 19 above. Layers of wired/wireless interface protocol may be implemented by the processor 2411. The memory 2412, being connected to the processor 2411, stores various types of information for driving the processor 2411. The communication module 2413, being connected to the processor 2411, transmits and/or receives wired/wireless signals. The communication module 2413 may include a radio frequency unit (RF) unit for transmitting/receiving wireless signals.

The UE includes a processor 2421, a memory 2422, and a communication module (or RF unit) 2413. The processor 2421 implements the functions, processes and/or methods proposed in FIGS. 1 to 19 above. Layers of a wireless interface protocol may be implemented by the processor 2421. The memory 2422, being connected to the processor 2421, stores various types of information for driving the processor 2421. The communication module 2423, being connected to the processor 2421, transmits and/or receives wireless signals. The memory 2412, 2422 can be installed inside or outside the processor 2411, 2421 and connected to the processor 2411, 2421 through various well-known means.

The base station 2410 and/or the UE 2420 may have a single antenna or multiple antennas.

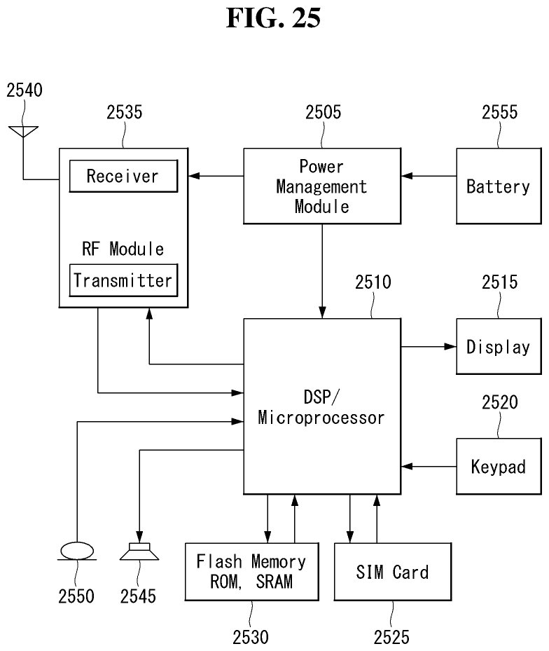

FIG. 25 illustrates a block diagram of a communication device according to an embodiment of the present disclosure. FIG. 25 illustrates the UE of FIG. 24 above in more detail.

Referring to FIG. 25, the UE includes a processor (or digital signal processor (DSP)) 2510, an RF module (or RF unit) 2535, a power management module 2505, an antenna 2540, a battery 2555, a display 2515, a keypad 2520, a memory 2530, a subscriber identification module (SIM) card 2525 (which may be optional), a speaker 2545 and a microphone 2550. The UE may include a single antenna or multiple antennas.

The processor 2510 may be configured to implement the functions, processes and/or methods proposed in FIGS. 1 to 23 above. Layers of a wireless interface protocol may be implemented by the processor 2510.

The memory 2530 is connected to the processor 2510 and stores information related to operations of the processor 2510. The memory 2530 may be located inside or outside the processor 2510 and may be connected to the processor 2510 through various well-known means.

A user enters command information, such as a telephone number, for example, by pushing (or touching) buttons of the keypad 2520 or by voice activation using the microphone 2550. The processor 2510 receives the command information and processes to perform the appropriate function, such as to dial the telephone number. Operational data may be extracted from the SIM card 2525 or the memory 2530. Furthermore, the processor 2510 may display the command information or operational information on the display 2515 for the user's recognition and convenience.

The RF module 2535 is connected to the processor 2510 to transmit and/or receives an RF signal. The processor 2510 forwards the command information to the RF module 2535, to initiate communication, for example, to transmit wireless signals comprising voice communication data. The RF module 2535 is comprised of a receiver and a transmitter for receiving and transmitting the wireless signals. The antenna 2540 functions to transmit and receive wireless signals. Upon receiving the wireless signals, the RF module 2535 may forward the signal for processing by the processor 2510 and convert the signal to baseband. The processed signals may be converted into audible or readable information output via the speaker 2545.

In the aforementioned embodiments, the elements and characteristics of the present disclosure have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present disclosure. Order of the operations described in the embodiments of the present disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

An object of the present disclosure is to provide a method for measuring (or calculating) an altitude of an unmanned aerial robot in an unmanned aerial system.

In addition, an object of the present disclosure is to provide a method for accurately measuring an altitude using a beam generated from a light source of an unmanned aerial robot, image information of the ground by a camera and a reference drawing.

In addition, an object of the present disclosure is to provide a method for controlling an altitude of an unmanned aerial robot by measuring a current altitude of the unmanned aerial robot.

Technical objects to be achieved by the present disclosure are not limited to the aforementioned technical objects, and other technical objects not described above may be evidently understood by a person having ordinary skill in the art to which the present disclosure pertains from the following description.

The present disclosure provides an altitude measuring method of an unmanned aerial robot. In the present disclosure, the method includes adjusting a level of the unmanned aerial robot so that the unmanned aerial robot is level with the ground; generating a plurality of laser beams to the ground in the horizontal state; capturing image of the ground through a camera; and calculating a vertical distance from the ground to the unmanned aerial robot based on the captured image of the ground and the plurality of laser beams, wherein the vertical distance is calculated based on a horizontal ground distance from the position of the unmanned aerial robot on the ground to one end point of the image and a specific angle, wherein the specific angle is an angle between the vertical distance and the distance between the unmanned aerial robot and the one end point of the image, and wherein the ground distance is determined based on a reference distance.

In addition, in the present disclosure, when the plurality of laser beams are two, the reference distance may be half of a distance between the two laser beams.

In addition, in the present disclosure, when the reference distance is different from the ground distance by a specific multiple, the ground distance may be calculated by multiplying the reference distance by the specific multiple.

In addition, in the present disclosure, when the ground distance is Wd, the specific multiple is K, and the reference distance is W1, the ground distance is calculated through the following equation.

Wd=K*W1

In addition, in the present disclosure, the vertical distance is calculated through a trigonometric function between the ground distance and the angle.

In addition, in the present disclosure, when the vertical distance is hd, the ground distance is Wd, and the angle is θ, the vertical distance hd is calculated through the following equation.

Wd=hd*tan θ

In addition, the present disclosure may further include comparing the vertical distance with a target height of the unmanned aerial robot; and adjusting the vertical distance to the target height when the vertical distance and the target height are not the same.

In addition, the present disclosure includes a main body; a camera provided in the main body; a plurality of light sources for generating a plurality of laser beams; at least one motor; at least one propeller connected to each of the at least one motor; and a processor electrically connected to the at least one motor to control the at least one motor, wherein the processor configured to adjust a level of the unmanned aerial robot so that the unmanned aerial robot is level with the ground, generate the plurality of laser beams from the plurality of light sources to the ground in the horizontal state, capture image of the ground through the camera, and calculate a vertical distance from the ground to the unmanned aerial robot based on the captured image of the ground and the plurality of laser beams, wherein the vertical distance is calculated based on a horizontal ground distance from the position of the unmanned aerial robot on the ground to one end point of the image and a specific angle, wherein the specific angle is an angle between the vertical distance and the distance between the unmanned aerial robot and the one end point of the image, and wherein the ground distance is determined based on a reference distance.

According to the present disclosure, there is an effect that can accurately measure the altitude of the unmanned aerial robot without being affected by the external environment (for example, draft, rain, noise, etc.) by measuring the altitude using the beam generated from the light source of the unmanned aerial robot.

In addition, the present disclosure has an effect capable of measuring the altitude of the unmanned aerial robot even in a narrow space by measuring the altitude using image information of the ground through the camera of the unmanned aerial robot and the beam generated from the light source.

Hereinafter, embodiments disclosed in this specification are described in detail with reference to the accompanying drawings. The same or similar reference numerals are assigned to the same or similar elements regardless of their reference numerals, and redundant descriptions thereof are omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing the embodiments disclosed in this specification, a detailed description of a related known technology will be omitted if it is deemed to make the gist of the present disclosure unnecessarily vague. Furthermore, the accompanying drawings are merely intended to make easily understood the exemplary embodiments disclosed in this specification, and the technical spirit disclosed in this specification is not restricted by the accompanying drawings and includes all modifications, equivalents, and substitutions which fall within the spirit and technological scope of the present disclosure.

Terms including ordinal numbers, such as the first and the second, may be used to describe various elements, but the elements are not restricted by the terms. The terms are used to only distinguish one element from the other element.

When it is said that one element is “connected” or “coupled” to the other element, it should be understood that one element may be directly connected or coupled” to the other element, but a third element may exist between the two elements. In contrast, when it is said that one element is “directly connected” or “directly coupled” to the other element, it should be understood that a third element does not exist between the two elements.

An expression of the singular number may include an expression of the plural number unless clearly defined otherwise in the context.

It is to be understood that in this application, a term, such as “include” or “have”, is intended to designate that a characteristic, number, step, operation, element, part or a combination of them described in the specification is present, and does not exclude the presence or addition possibility of one or more other characteristics, numbers, steps, operations, elements, parts, or combinations of them in advance.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A height measuring method of a robot, comprising:
adjusting the robot to be level with a surface;
providing, by the robot, a plurality of laser beam spots on the surface;
capturing, by a camera of the robot, an image of the surface; and
determining, by the robot, a vertical distance from the surface to the robot based on the captured image and the plurality of laser beam spots on the surface,
wherein the vertical distance is determined based on a horizontal surface distance from a position of the robot on the surface to a first end point of the image and a specific angle,
wherein the specific angle is an angle between the vertical distance and the surface distance between the robot and the first end point of the image, and
wherein the surface distance is determined based on a reference distance.

2. The method of claim 1, wherein when the plurality of laser spots are two laser beam spots, the reference distance is half of a distance between the two laser beam spots on the surface.

3. The method of claim 2, wherein when the reference distance is different from the surface distance by a specific multiple, the surface distance is determined by multiplying the reference distance by the specific multiple.

4. The method of claim 3, wherein when the surface distance is Wd, the specific multiple is K, and the reference distance is W1, the surface distance is determined based on the following equation.
Wd=K*W1

5. The method of claim 1, wherein the vertical distance is determined based on a trigonometric function between the surface distance and the angle.

6. The method of claim 1, wherein when the vertical distance is hd, the surface distance is Wd, and the angle is θ, the vertical distance hd is determined based on the following equation.
Wd=hd*tan θ

7. The method of claim 1, further comprising:
comparing the vertical distance with a target height of the robot; and
adjusting the vertical distance to the target height when the vertical distance is not the same as the target height.

8. A robot for determining a height, the robot comprising:
a main body;
a camera provided at the main body;
a plurality of light sources for generating a plurality of laser beams;
at least one motor;
at least one propeller connected to each of the at least one motor; and
a processor electrically connected to the at least one motor to control the at least one motor,
wherein the processor is configured to:
adjust the robot to be level with a surface;
provide, on the surface, a plurality of laser beam spots based on the plurality of light sources;
capture, by the camera, an image of the surface; and
determine a vertical distance from the surface to the robot based on the captured image of the surface and the plurality of laser beam spots,
wherein the vertical distance is determined based on a horizontal surface distance from a position of the robot on the surface to a first end point of the image and a specific angle,
wherein the specific angle is an angle between the vertical distance and the surface distance between the robot and the first end point of the image, and
wherein the surface distance is determined based on a reference distance.

9. The robot of claim 8, wherein when the plurality of laser beam spots are two laser beam spots, the reference distance is half of a distance between the two laser beam spots on the surface.

10. The robot of claim 9, wherein when the reference distance is different from the surface distance by a specific multiple, the surface distance is determined by multiplying the reference distance by the specific multiple.

11. The robot of claim 10, wherein when the surface distance is Wd, the specific multiple is K, and the reference distance is W1, the surface distance is determined based on the following equation.
Wd=K*W1

12. The robot of claim 8, wherein the vertical distance is determined based on a trigonometric function between the surface distance and the angle.

13. The robot of claim 8, wherein when the vertical distance is hd, the surface distance is Wd, and the angle is θ, the vertical distance hd is determined based on the following equation.
Wd=hd*tan θ

14. The robot of claim 8, wherein the processor is configured to:
compare the vertical distance with a target height of the robot; and
adjust the vertical distance to the target height when the vertical distance is not the same as the target height.

15. A measuring method of a robot, comprising:
providing, by the robot, a plurality of laser beam spots on the surface;
capturing, by a camera of the robot, an image of the surface; and
determining, by the robot, a vertical distance from the surface to the robot based on the captured image and the plurality of laser beam spots on the surface,
wherein the vertical distance is determined based on a surface distance and a specific angle between the vertical distance and the surface distance, and
wherein the surface distance is determined based on a reference distance.

16. The method of claim 15, wherein the surface distance is determined based on a position of the robot on the surface and a first end point of the image.

17. The method of claim 16, wherein when the plurality of laser spots are two laser beam spots, the reference distance is half of a distance between the two laser beam spots on the surface.

18. The method of claim 17, wherein when the reference distance is different from the surface distance by a specific multiple, the surface distance is determined by multiplying the reference distance by the specific multiple.

19. The method of claim 15, wherein the vertical distance is determined based on a trigonometric function between the surface distance and the angle.

20. The method of claim 15, further comprising:
comparing the vertical distance with a target height of the robot; and
adjusting the vertical distance to the target height when the vertical distance is not the same as the target height.
